(19) United States
(12) Patent Application Publication
(10) Pub. No.: US 2012/0101960 A1
(43) Pub. Date: Apr. 26, 2012

(54) METHOD AND SYSTEM FOR THE ACQUISITION, EXCHANGE AND USAGE OF FINANCIAL INFORMATION

(76) Inventor: Sylvain CHASSANG, Princeton, NJ (US)

(21) Appl. No.: 13/278,656

(22) Filed: Oct. 21, 2011

Related U.S. Application Data
(60) Provisional application No. 61/405,843, filed on Oct. 22, 2010.
(60) Provisional application No. 61/419,291, filed on Dec. 3, 2010.

(51) Int. Cl. G06Q 40/06

(52) U.S. Cl. 705/36 R

(57) ABSTRACT

The present invention includes a robust automated asset allocation optimization layer that optimizes between an allocation suggested by one or more managers, or allocations induced by information provided by managers, and a default allocation that is either provided by the client, or generated by the system. A second layer of the system tracks the amount of resources allocated to each manager, and computes and implements adequate dynamic rewards to managers as a function of their performance.

### CROSS REFERENCE TO RELATED APPLICATION

This application claims the benefit of U.S. Provisional Patent Application No. 61/405,843 filed Oct. 22, 2010 and U.S. Provisional Patent Application No. 61/419,291 filed Dec. 3, 2010, the entireties of applications which are hereby incorporated by reference into this application.

### BACKGROUND OF THE INVENTION

1. Field of the Invention

The invention relates to a method and system to structure the acquisition, exchange and usage of financial information. The invention includes two main components. The first component of the system is a flexible method to collect and optimize the use of various forms of financial information. The second component of the system is a method to dynamically evaluate the performance of, and implement adequate rewards for agents providing financial information.

2. Description of Related Art

Methods to optimize financial allocations are known. A class of simple automated trading rules that can approximate the growth rate of the best constantly rebalanced portfolio of assets over the long run have been described in Cover, T. “Universal portfolios,” Mathematical Finance, 1, 1-29 (1991), Cover, T. et al., “Universal portfolios with side information,” IEEE Transactions on Information Theory, 42, 348-363 (1996), and Blum, A. et al. “Universal portfolios with and without transaction costs,” Machine Learning, 35, 193-205 (1999). These methods are robust to linear trading costs. However, these methods have limitations. Fixed portfolios constitute a relatively low performance target to achieve. In many environments, it may be needed to shift frequently across portfolios to obtain an attractive performance, especially if the assets underlying the portfolios correspond to asset allocation strategies generated by wealth managers whose talent and information varies over time. In addition, the assumption of linear trading costs is often wrong given the ubiquity of fixed-costs in practice.

The exchange of financial information between a client (the principal) and her hired wealth manager (the agent) is well known. It is well documented that because of limited liability on the side of managers, the interests of clients and their hired managers are difficult to align. Because financial managers are not liable for losses, financial managers can be significantly rewarded for luck while providing only limited value-added to their clients. It has been described that if wealth managers have low value-added, the best investment strategy may consist of seeking well diversified investment vehicles that carry low management fees. The asset management company Vanguard was setup to offer such low-cost investment vehicles.

An alternate approach, is to find ways to align the interests of managers and their clients. Devising practical methods to achieve such alignment has troubled law makers. Improved scoring rules to evaluate managers are described in Goetzmann, W. et al., “Portfolio Performance Manipulation and Manipulation-Proof Performance Measures,” Review of Financial Studies (2007). Unfortunately, implementing such scoring rules is effectively impossible unless the liability of wealth managers is increased, as described in Foster, D. et al., “Gaming Performance Fees By Portfolio Managers,” The Quarterly Journal of Economics (2010). It has been suggested that large clawback provisions can be used, requiring managers to reimburse past pay in the event of poor subsequent performance. The use of such clawbacks is problematic since it effectively requires large ongoing liability from managers, which may end up limiting the entry of small competitive financial firms.

It is desirable to devise robust methods to optimize asset allocations that: approximate the growth rate of the best portfolio over any subperiod; manage trading costs effectively regardless of the structure of trading costs, including fixed costs; optimize leverage under pre-specified allocation constraints; and extract information from agents in effective and flexible ways. It is also desirable to provide a method to properly align the incentives of managers with the interests of their clients without requiring clawbacks or excessive liability.

### SUMMARY OF THE INVENTION

The present invention includes a robust automated asset allocation optimization layer that optimizes between an allocation suggested by one or more managers, allocations induced by information provided by managers, and a default allocation that is either provided by the client, or generated by the system. The managers may be actual managers distinct from the agent, or may be abstract managers used to represent potential investment strategies. A second layer of the system tracks the amount of resources allocated to each manager and computes adequate dynamic rewards to managers as a function of their performance. Preferably the second layer is implemented in conjunction with the first allocation optimization layer.

Different embodiments for each of the components of the system of a flexible method to collect and optimize the use of various forms of financial information and a method to dynamically evaluate the performance of, and implement adequate rewards for agents providing financial information, are to allow for: optimized assignment of wealth to invest across multiple agents; cost-efficient allocation optimization; leveraged allocation optimization; contextual allocation optimization; labeled allocation optimization; flexible-preference allocation optimization; tree allocation optimization; discounted performance evaluation; reward hurdles permitting the efficient screening of talented and untalented agents; multiple overlapping investors; third party and encrypted implementation of trades; and deferred payments.

The present invention provides a set of asset allocation methodologies that effectively exploit temporary shifts in trends. The asset allocation methodologies can include constructing responsive measures of regret over different possible allocations and then employing appropriate regret minimization procedures. Various embodiments of the system allow for trading-cost control that is effective regardless of the structure of costs, including fixed costs; leverage optimization; and risk-preference adjustments. In addition the present invention offers methods to acquire and use private information in flexible ways including contextual allocation optimization, labeled allocation optimization, and tree optimization.

The present invention also aims to resolve the problem of aligning the incentives of managers and clients. In one embodiment, the system takes as input an appropriate default asset allocation, which would have been used in the absence of a hired asset manager, and an asset allocation suggested by a hired manager or induced by the information provided by the manager. There may be multiple asset managers, including abstract managers used to embody various pre-specified asset allocation strategies. Resources are distributed to the various suggested asset allocations according to a robust asset allocation optimizing system that treats each manager as an asset. The manager's contribution is then computed based on the share of assets assigned to the manager to manage and the returns which are generated. The flow payoffs of the manager are then implemented according to a dynamic procedure which seeks to approximate an ideal reward scheme. A variant of the system allows for screening of talented and untalented managers, which allows to scale up the system to a large number of potential managers of uncertain talent.

The invention will be more fully described by reference to the following drawings.

### BRIEF DESCRIPTION OF THE DRAWINGS

FIG. 1 is a diagram of a method to structure the acquisition, exchange and usage of financial information.

FIG. 2 is a diagram of a method to structure the acquisition of financial information.

FIG. 3 is a diagram of a method to structure the acquisition of financial information.

FIG. 4 is a diagram of a method to optimize the allocation of financial assets.

FIG. 5 is a diagram of a method to optimize the allocation of financial assets in the presence of trading costs.

FIG. 6 is a diagram of a method to optimize leverage.

FIG. 7 is a diagram of a method to optimize the allocation of financial assets when contextual information is available.

FIG. 8 is a diagram of a method to optimize the allocation of financial assets when asset labels are available.

FIG. 9 is a diagram of a method to optimize the allocation of financial assets when risk-preferences can change.

FIG. 10 is a diagram of a method to optimize the allocation of financial assets when risk-preferences can change.

FIG. 11 is a diagram of a method to optimize the allocation of financial assets in the presence of tree-structured information.

FIG. 12 is a diagram of a method to evaluate and validate asset allocations.

FIG. 13 is a diagram of a method to structure the usage, exchange and reward of financial information which aligns the interests of managers and clients.

FIG. 14 is a diagram of a method to structure the usage, exchange and reward of financial information which aligns the interests of managers and clients and allows for screening of untalented managers.

FIG. 15 is a diagram of a method to structure the usage, exchange and reward of financial information which allows for multiple overlapping investors.

FIG. 16 is a diagram of a method to structure the usage, exchange and reward of financial information which allows for secure management of the information provided by managers.

FIG. 17 is a diagram of a method to structure dynamic rewards to managers using deferred payment accounts.

FIG. 18 is a diagram of a method to optimize the allocation of financial assets.

FIG. 19 is a schematic diagram of a system for the acquisition, exchange and usage of financial information.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

Calibration techniques are defined as follows. Take as given sequences of choice variables (σₜ)_{t≧0}, states (ωₜ)_{t≧0}, and given any T ∈ [symbol] , a target function Y└(σₜ)_{t∈{0, . . . , T}}, (ωₜ)_{t∈{0, . . . , T}}┘ and a guided function X└(σₜ)_{t∈{0, . . . , T}}, (ωₜ)_{t∈{0, . . . T}}┘. Choice variables (σₜ)_{t∈N} are calibrated so that X approaches Y if for all sequences of states (ωₜ)_{t>0}, X └(σₜ)_{t∈{0, . . . , T}}, (ωₜ)_{t∈{0, . . . , T}}┘ becomes arbitrarily close (converges) to Y └(σₜ)_{t∈{0, . . . , T}}, (ωₜ)_{t∈{0, . . . , T}}, as T becomes large. Appropriate normalization by a factor of 1/T may be needed. The calibration method can be implemented in a computer. It will be appreciated that any calibration method can be used, including for example, gradient descent as described in Cesa-Bianchi and Lugosi pages 7-37 and 100-107 (2006) which is hereby incorporated by reference in its entirety into this application.

Fundamental assets correspond to actual assets that can be traded on existing exchanges. Example fundamental assets include stocks, bonds, currencies, derivatives, and the like. Assets are characterized by their returns process (rₜ)_{t≧0}. In each period t asset κ generates returns r_{κ,t}∈ [symbol] . If the price of asset κ is p_{κ,t} at the beginning of period t, returns in period t are given by r_{κ,t}=(p_{κ,t+1}−p_{κ,t})/P_{κ,t}. An asset allocation is a vector of weights a=(a₁, . . . , a_{K})∈ [symbol] ^{K} such that Σ_{κ-1}^{K}a_{κ}=1, which represents a way to allocate a unit of wealth across different assets.

A complex or abstract asset is an implementable allocation strategy that gives rise to a returns process (rₜ)_{t≧0}. This may be a fundamental asset, a portfolio of fundamental assets, the returns process generated by a manager, and the like. A manager is defined as a person or entity who manages or provides information to manage the assets of a client. Abstract managers may be used to represent pre-specified asset allocation strategies. The system of the present invention can optimize resource allocation over both fundamental and abstract assets.

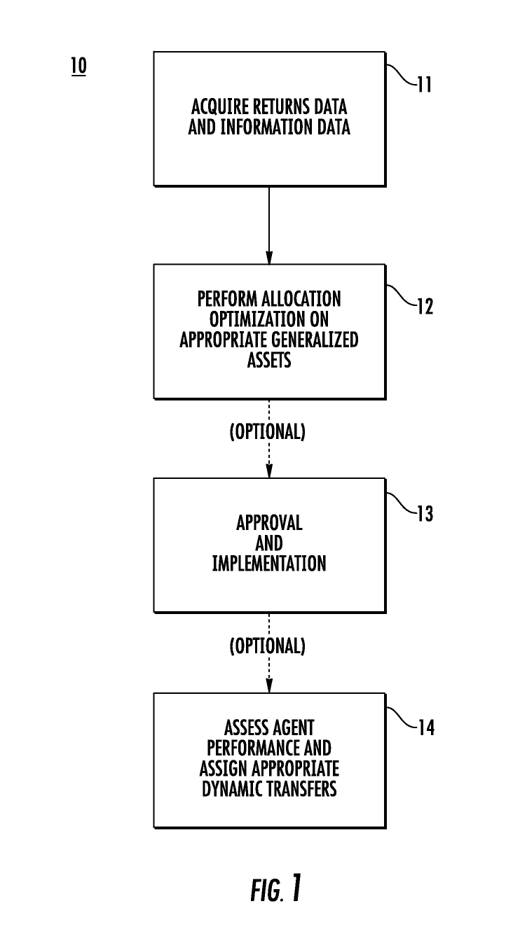

FIG. 1 is a diagram illustrating a method to structure the acquisition, exchange and usage of financial information 10.

In block 11 financial information is acquired. Financial information can include public information concerning realized returns, default asset allocations, asset allocations suggested by potential asset managers, information about the current state of the economy, subjective information in the form of abstract states or asset labels, and the like.

In block 12 optimization over various competing asset allocation strategies is performed. The underlying allocation strategies can include fixed allocations over fundamental assets, pre-specified information-dependent allocation strategies, allocation strategies suggested by a manager, or allocation strategies suggested by a client. Resources are assigned to allocation strategies as a function of their historical performance in a manner that ensures the said strategies do not cause significant loss in value, but without crippling their performance on the upside. The present invention provides efficient methods to control trading costs and optimize leverage.

In block 13, which is optional, allocations are evaluated and validated before their implementation by a client.

In block 14, which is optional, the performance of managers is assessed and appropriate rewards are dynamically implemented under limited liability constraints. In order to align the interests of managers and their clients, it is preferable that block 14 be implemented on managers whose investment base is scaled according to the allocation optimization performed in block 12.

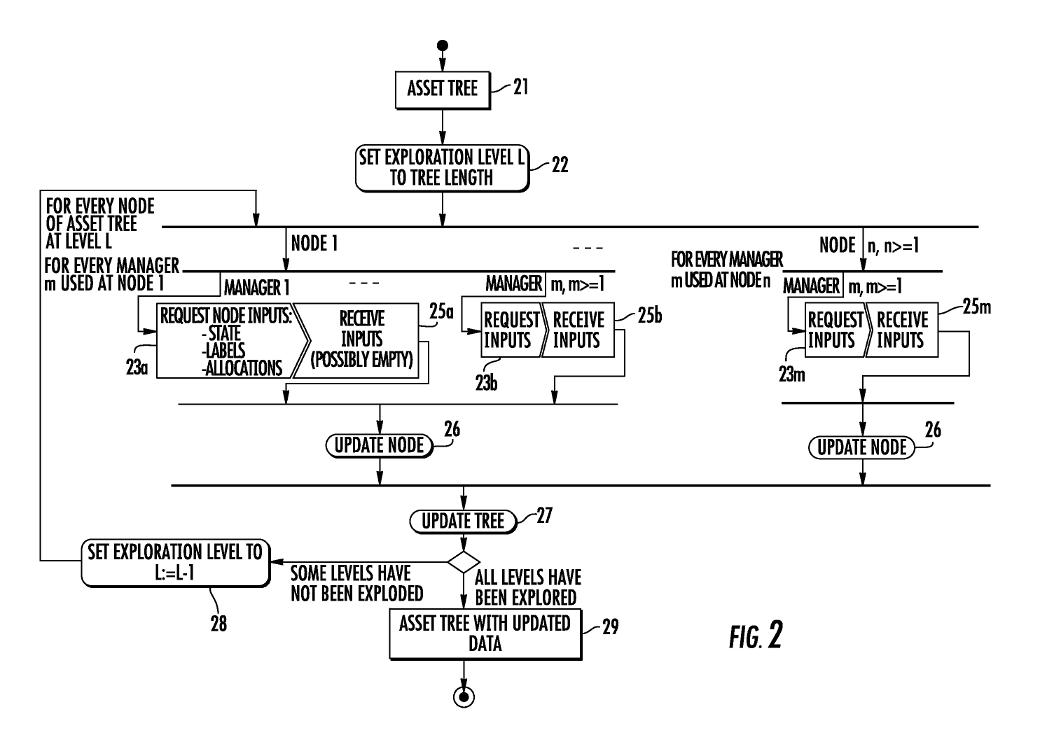

FIG. 2 is a flow diagram of a method to acquire information and asset allocation suggestions from different sources as per block 11 of FIG. 1, to be used as an input for the asset allocation optimization methods shown in block 12. Information acquisition can be ongoing and performed at regular time intervals.

In block 21, assets are organized in an asset tree structure. The asset tree structure can be used as a way to represent structure on assets, and asset allocation strategies. For instance assets may be first grouped by type (bonds, stocks, . . . ) then by country of origin, and so on. This includes the special case where no structure is imposed on assets.

In block 22, an order to explore nodes of the asset tree is determined. In one embodiment, the order is determined in order of decreasing distance from the root node and the exploration level L is set to the tree length. At each node, past returns and past asset allocations over children nodes are recorded, and potential managers may be given the opportunity to: input states; assign labels to children nodes; and suggest asset allocations over children nodes. It will be appreciated that other determinations of the order in which nodes are explored can be used in accordance with the teachings of the present invention.

In blocks 23a-m, for each node being selected, inputs are requested from every manager listed under that node. In blocks 25a-m, inputs from the respective managers are received. The list of managers under a node can include abstract managers representing default asset allocation strategies, for example dummy managers that suggest a constant asset allocation such as S&P 500, treasury bonds, gold or a fixed portfolio with constant shares. In block 26, each node is dynamically updated with the received input. In block 27, the asset tree is updated with the updated nodes. If some levels have not yet been explored, the exploration level is set to L=L−1 in block 28 and the system returns to respective blocks 23a-23m and 25a-25m. If all levels have been explored, the fully updated asset tree is returned in block 29.

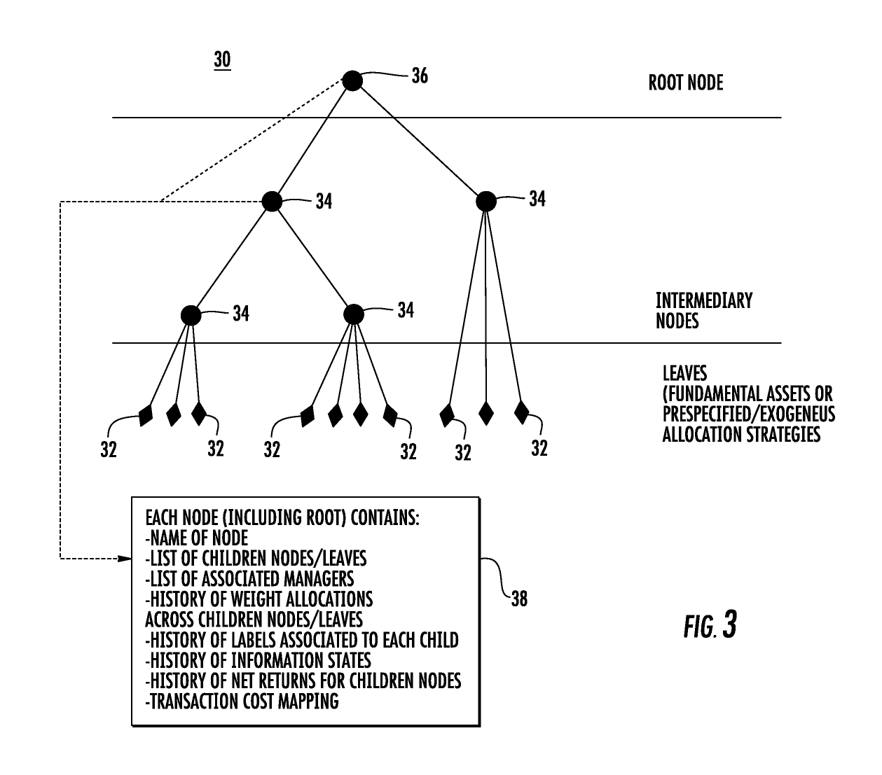

FIG. 3 is an embodiment of block 21 specifying an asset tree structure 30. Asset tree structure 30 comprises leaves 32, intermediary nodes 34 and root node 36. Leaves 32 are assigned exogenous underlying asset allocations, which can correspond to fundamental assets, pre-specified asset allocation strategies, or allocation strategies suggested by a manager. Treating an allocation strategy suggested by a manager as an asset allows to include the manager as an asset in an asset allocation optimization procedure. The same assets can be assigned multiple times to different leaves 32.

Intermediary nodes 34 are used to categorize assets. Each intermediate node 34 contains a subset of the following information, as shown in block 38: a name for the node; a list of children nodes or leaves; a list of managers allowed to input information or suggest asset allocations; a history of weight allocations over children nodes or leaves; a history of labels associated with children nodes, a history of information states associated with the node; the history of gross and net returns; and a trading cost structure over children nodes specifying the cost of moving from one allocation over children nodes to an other.

Root node 36 is an intermediary node which does not have a parent. In one embodiment, asset tree structure 30 can be reduced to only one root node 36 and leaves 32.

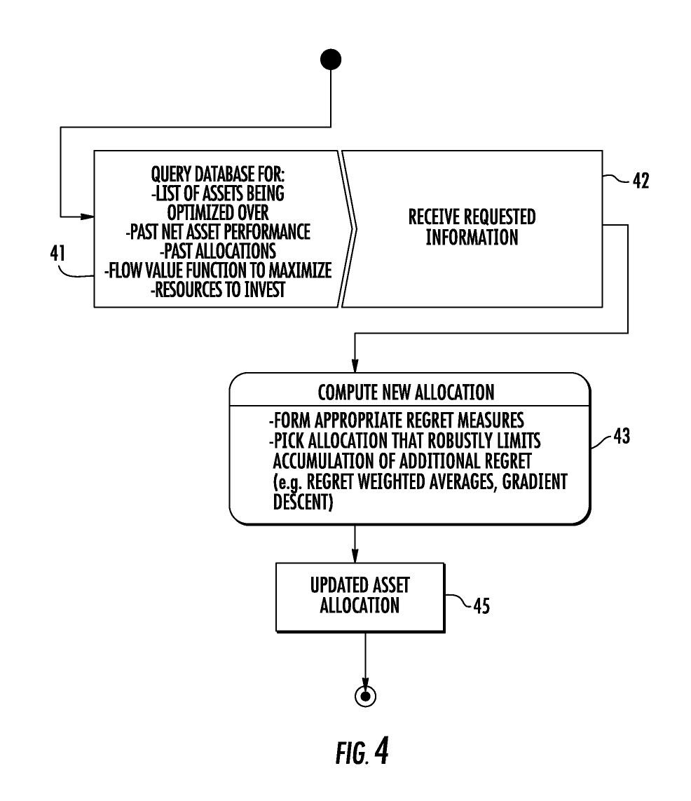

FIG. 4 is a flow diagram representing an embodiment of a robust and flexible method to optimize among a number of possible assets shown in block 12. The assets can themselves correspond to allocation strategies. The method guarantees that over any time interval, the resulting optimized asset allocation strategy has approximately the same return performance as the underlying asset which turns out to perform best over that length of time. The underlying assets are denoted by κ∈K where κ is the name of an asset, and their returns are denoted by (r_{κ,t})_{κ∈K,t≧0} where t is the time period. Unless mentioned otherwise, returns are net returns. In particular, if the asset in question is an asset allocation strategy suggested by a manager, returns should be net of management fees paid out to the manager.

In block 41, a database is queried for the data necessary to implement the robust optimizer at time T. The data can include: a list K of asset being optimized over;

the history (r_{κ,t})_{κ∈K,t∈{0, . . . , T-1}} of net asset returns;

the history of asset allocations (aₜ)_{t∈{0, . . . , T-1}}, where aₜ is a vector aₜ=(a_{κ,t})_{κ∈K}∈[0,1]^{K} such that Σ_{κ=K}a_{κ,t}=1, and the corresponding returns defined by rₜ=Σ_{κ∈K}a_{κ,t}r_{κ,t};

resources ω_{T} to be invested at time T;
and a flow value function u(rₜ, ωₜ) over returns rₜ and initial wealth ωₜ in period t, representing the objective to be optimized. Prominent possible choices for

u(•,•) are:
u(rₜ,ωₜ)=rₜωₜ;
u(rₜmωₜ)=ln(1+rₜ) .

It will be appreciated that any utility function over flow wealth can be used in accordance with the teachings of the present invention.

In block 42, requested information is received.

In block 43, allocation optimization is determined in a computer. An appropriate regret measure is determined and an allocation is selected that robustly limits accumulation of additional regret. For example, regret minimization protocols can include regret weighted averages and gradient descent. For each asset an appropriate regret measure [symbol] _{κ,T} is computed as a function of past data according to the following formula:

$${κ , T}_{} = \begin{matrix}max \\ {T}^{′} \leq T\end{matrix} {\sum }_{t = {T}^{′}}^{T} u ( {r}_{k , t} , {\underline{ω}}_{t} ) - u ( {r}_{t} , {\underline{ω}}_{t} ) .$$

If assets are not available in every period, this regret measure can be generalized by setting

$${κ , T}_{} = \begin{matrix}max \\ {T}^{′} \leq T\end{matrix} \frac{T - {T}^{′} + 1}{{\sum }_{t = {T}^{′}}^{T} {1}_{κ available at t}} \times {\sum }_{t = {T}^{′}}^{T} [ u ( {r}_{κ , t} , {\underline{ω}}_{t} ) - u ( {r}_{t} , {\underline{ω}}_{t} ) ] {1}_{κ available at t} .$$

Alternatively, regrets [symbol] _{κ,T}=max{0,Σₜ₌₀^{T} ₀u(r_{κ,t},ωₜ)−u(rₜ,ωₜ)} may be used at some small performance loss.

The corresponding vector of regrets is denoted by [symbol] _{T}=( [symbol] _{κ,T})_{κ∈K}. The asset allocation (aₜ)_{t≧0} is calibrated so that vector of regrets [symbol] _{T} approaches 0. This can be achieved by systematically choosing the allocation a_{T} that minimizes the marginal regret functional ω( [symbol] _{T-1},a_{T}) given by

$$ψ ( {T - 1}_{} , {a}_{T} ) = \vert {\sum }_{κ ∈ K} ( {κ , T - 1}_{} - {a}_{k , T} {\sum }_{\hat{κ} ∈ K} {\hat{κ} , T - 1}_{} ) \vert ,$$

which leads to the allocation

$$∀ κ ∈ K , {a}_{κ , T} = \frac{{κ , T - 1}_{}}{{\sum }_{\hat{κ} ∈ K} {\hat{κ} , T - 1}_{}} .$$

It will be appreciated that the allocation (aₜ)_{t≧0} can be calibrated using any gradient descent approach based on appropriate regret potentials in accordance with the teachings of the present invention. For example, in the case of exponential potentials, the allocation takes the form

$$∀ κ ∈ K , {a}_{κ , T} = \frac{exp ( {δ}_{T} {κ , T - 1}_{} )}{{\sum }_{\hat{κ} ∈ K} exp ( {δ}_{T} {\hat{κ} , T - 1}_{} )} ,$$

with δ_{T} of the form δ_{T}=δ₀/\sqrt{T}, or δ_{T}=δ₀/Σ_{78 ∈K} [symbol] _{κ,T}. In block 45, the asset allocation is updated with the computed optimized allocation.

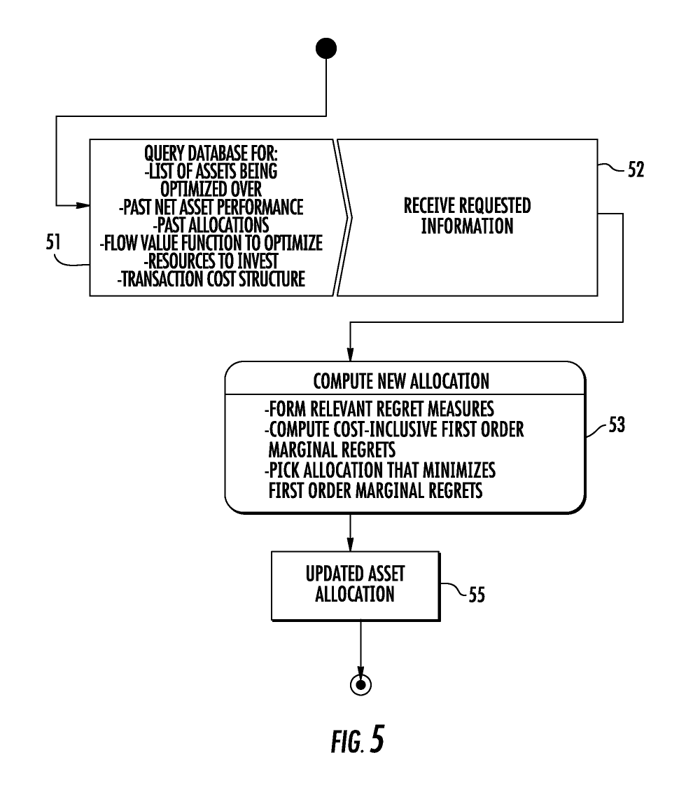

FIG. 5 is an alternative embodiment of a flow diagram representing a robust and flexible method to optimize among a number of possible assets which may themselves correspond to allocation strategies and which in addition to the optimization shown in FIG. 4 also limits trading costs.

In block 51, a database is queried for the data necessary to implement the robust optimizer at time T. The database data can include a list of assets being optimized over, past net asset performance, past allocations, the flow value function to optimize, resources to invest, and a trading cost function c(a, a′,w) which represents the trading costs involved in moving wealth w from a current asset allocation a to a new asset allocation a′.

In block 52, requested information is received.

In block 53, allocation optimization is determined using a computer. As in block 43, for each asset an appropriate regret measure [symbol] _{κ,T} is computed as a function of past data according to the following formula:

$${κ , T}_{} = \begin{matrix}max \\ {T}^{′} \leq T\end{matrix} {\sum }_{t = {T}^{′}}^{T} u ( {r}_{κ , t} , {\underline{ω}}_{t} ) - u ( {r}_{t} , {\underline{ω}}_{t} ) .$$

If assets are not available in every period, this regret measure can be generalized by setting

$${κ , T}_{} = \begin{matrix}max \\ {T}^{′} \leq T\end{matrix} \frac{T - {T}^{′} + 1}{{\sum }_{t = {T}^{′}}^{T} {1}_{κ available at t}} \times {\sum }_{t = {T}^{′}}^{T} [ u ( {r}_{κ , t} , {\underline{ω}}_{t} ) - u ( {r}_{t} , {\underline{ω}}_{t} ) ] {1}_{κ available at t} .$$

In addition, in block 53, trading cost regret [symbol] _{c,T}=Σ_{t‘0}^{T}c(a_{t 1},aₜ,ωₜ)ₜ) is computed.

The allocation (a_{T})_{t≧0} is calibrated so that the vector of regrets [symbol] _{T}=( [symbol] _{κ,T}, [symbol] _{c,T})_{κ∈K} approaches 0 (using normalization by a factor 1/T). An appropriate procedure to achieve this is to systematically choose the allocation a_{T} that minimizes a marginal regret functional of the form

$$ψ ( {T - 1}_{} , {a}_{T - 1} , {a}_{T} ) = \vert {\sum }_{κ ∈ K} ( {κ , T - 1}_{} - {a}_{k , T} {\sum }_{\hat{κ} ∈ K} {\hat{κ} , T - 1}_{} ) \vert + γ ( T , {T - 1}_{} ) c ( {a}_{T - 1} , {a}_{T} , {\underline{ω}}_{T} )$$

where γ(•;•) is a weight function that-for instance-can be chosen of the form

γ(T, [symbol] _{T-1})=γ₀T^{ρ}+γ₁[ [symbol] _{c,T 1}]^{φ}

with γ₀, γ₁, ρ and φ positive parameters. For example, γ₀=0, γ₁=1 and φ=1; or γ₀=1, γ₁=0 and ρ=⅔ can be selected. Generally, parameters γ₀, γ₁, ρ and φ can be optimized to obtain good performance on past data. In block 55, the asset allocation is updated.

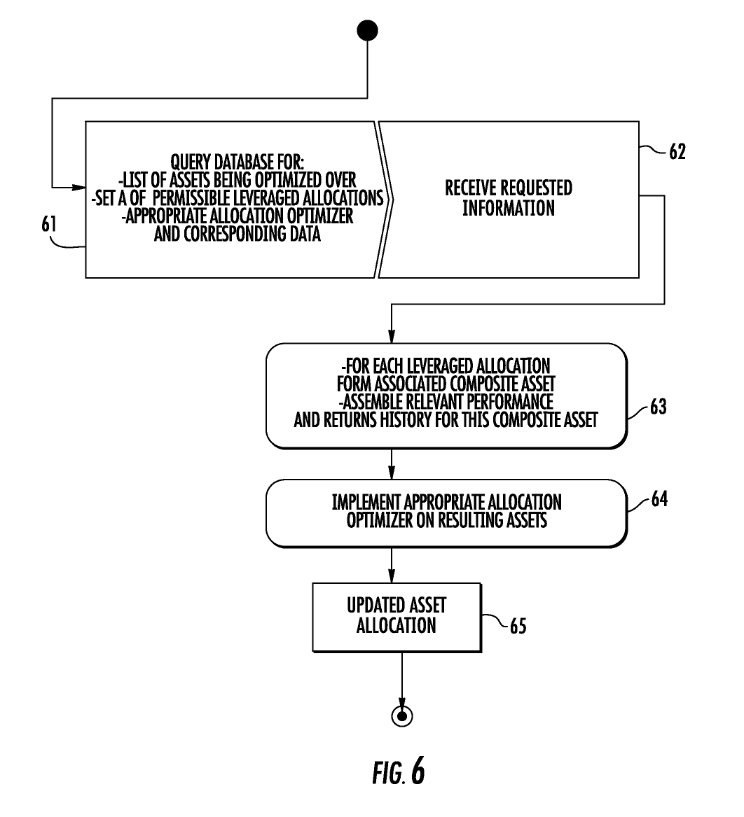

FIG. 6 is a flow diagram of an alternate embodiment representing a robust and flexible method to optimize among a number of possible allocation strategy which includes optimizing leverage while satisfying pre-specified allocation constraints.

In block 61, a database is queried for the data to implement the robust optimizer at time T. The database can include the data of the list K of assets κ being optimized over, a set A of permissible leveraged allocations, an allocation optimizer as described in FIG. 4 or 5, and the data required as input of the allocation optimizer. The set A of permissible allocations can vary with time. A leveraged allocation a^{lev ∈} A is such that Σ_{κ∈K}a_{κ}^{lev}=1, however, it may be that a_{κ}^{lev}∉[0,1] for some asset κ, in case the allocation is leveraged. In block 62 requested information is received.

Block 63 assembles and structures the data to implement the allocation optimization algorithms of FIGS. 4 and 5. If the set of permissible allocations A is finite, then consider every allocation a^{lev} Å A as an asset and construct the net returns (rₐ_{^{lev}}_{,t})_{t≧0} corresponding to that asset. If set A is continuous, it is first approximated by a finite set Â, for example using Monte Carlo or quasi-Monte Carlo sampling. The procedure described above is then applied to finite set Â.

In block 64, an optimized leveraged allocation is chosen by applying the optimization algorithms of FIGS. 4 and 5 on the returns data for allocations in A (or Â as the case may be). In block 65, the asset allocation is updated.

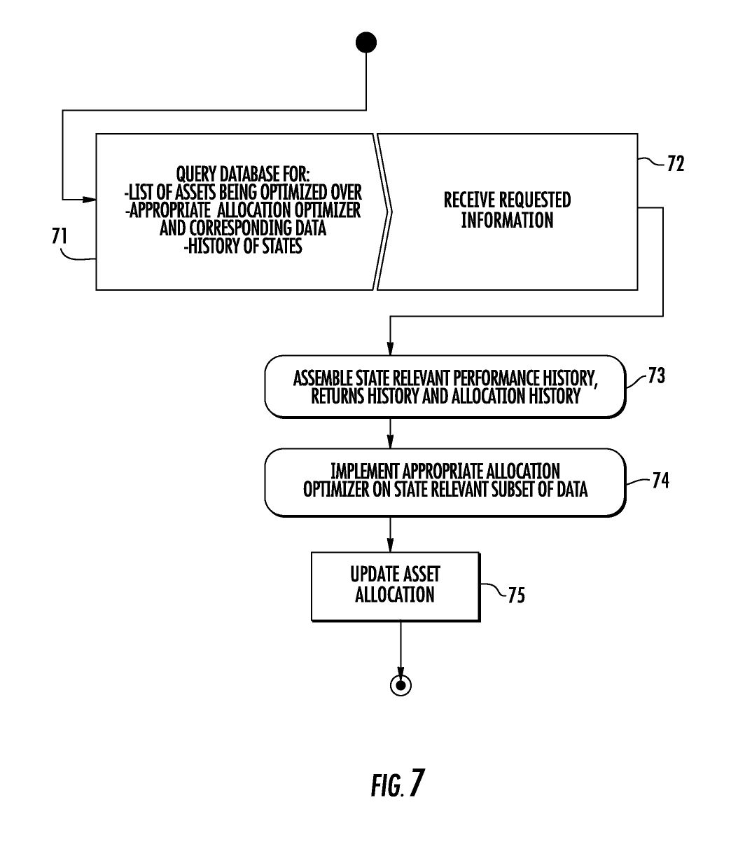

FIG. 7 is an alternate embodiment of a flow diagram representing a robust and flexible method to optimize among a number of possible allocation strategies which in addition to the optimization shown in FIGS. 4, 5 and 6 also exploits contextual information about the environment. In block 71, a database is queried for the data necessary to implement the robust optimizer at time T.

The database can include the data of the list of assets being optimized over, an appropriate allocation optimizer as described in FIG. 4, 5, or 6 and the data it requires, and the history of states (θₜ)_{t∈{0, . . . , T}}; where a state θ belongs to a finite set Θ.

In block 72, requested information is received.

Block 73 specifies that given a current state θ_{T} and for every asset κ∈ K, the history of allocations and returns for the subset of periods t where θₜ=θ_{T} is extracted. More formally, for every κ, the sub-history of returns (r_{κ,t})_{t,s,tθ}_{ₜ}_{=θ}_{_{T}} is extracted. This forms sub-assets corresponding to the behavior of assets in K when the state is θ_{T}.

Block 74 specifies that a contextual asset allocation is obtained by applying the procedures of FIG. 4, 5 or 6 on these sub-assets.

In block 75, the asset allocation is updated.

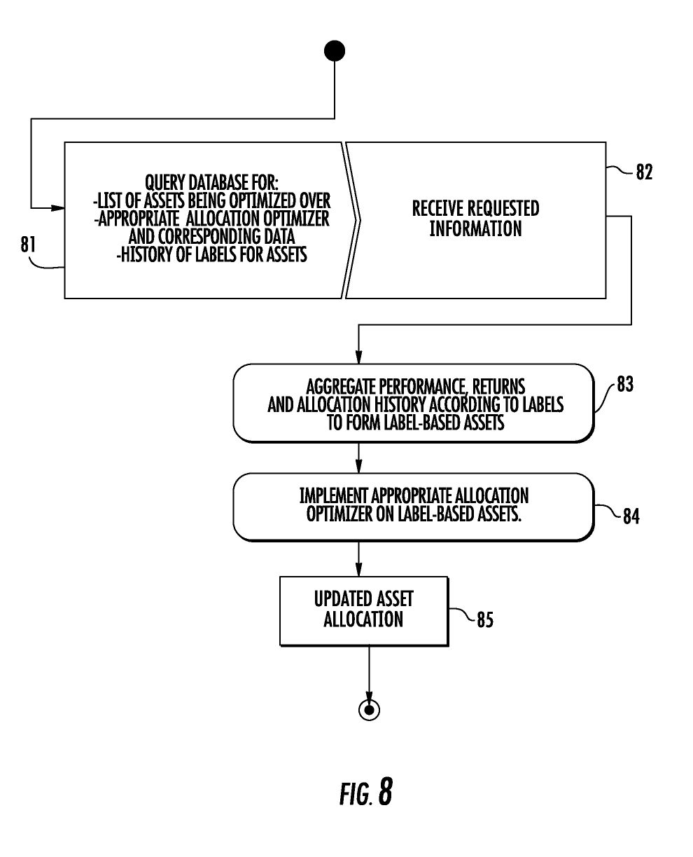

FIG. 8 is a flow diagram of an alternate embodiment representing a robust and flexible method to optimize among a number of possible allocation strategies by exploiting informative labels that can be assigned to assets.

Block 81 describes the data necessary for this procedure at time T+1: the list of assets being optimized over, an appropriate allocation optimizer (as described in FIG. 4, 5, 6, or 7) and the data it requires, the history of labels (ξ_{κ,t})_{κ∈K,t∈{0, . . . , T}}, where labels ξ belong to a finite set X and one label is assigned to each asset. Empty labels may be assigned by default.

Block 82 associates each label ξ with an asset with returns

$$∀ t , {r}_{ξ , t} = \frac{{\sum }_{κ ∈ K} {r}_{κ , t} {1}_{{ξ}_{κ , t} = ξ}}{{\sum }_{κ ∈ K} {1}_{{ξ}_{κ , t} = ξ}} .$$

In any period T, block 83 generates an allocation a_{T}^{lab}∈Δ(X) over labels by applying the procedures of FIG. 4, 5, 6 or 7 on the label-based assets described above. This induces an asset allocation over assets κ ∈ K by setting

$${a}_{T , κ} = {a}_{{ξ}_{κ , T} , T}^{lab} \times \frac{1}{{\sum }_{\hat{κ} ∈ K} {1}_{{ξ}_{\hat{κ} , T} = {ξ}_{κ , T}}} .$$

Block 84 specifies that a contextual asset allocation is obtained by applying the procedures of FIG. 4, 5 or 6 on these label based-assets. In block 85, the asset allocation is updated.

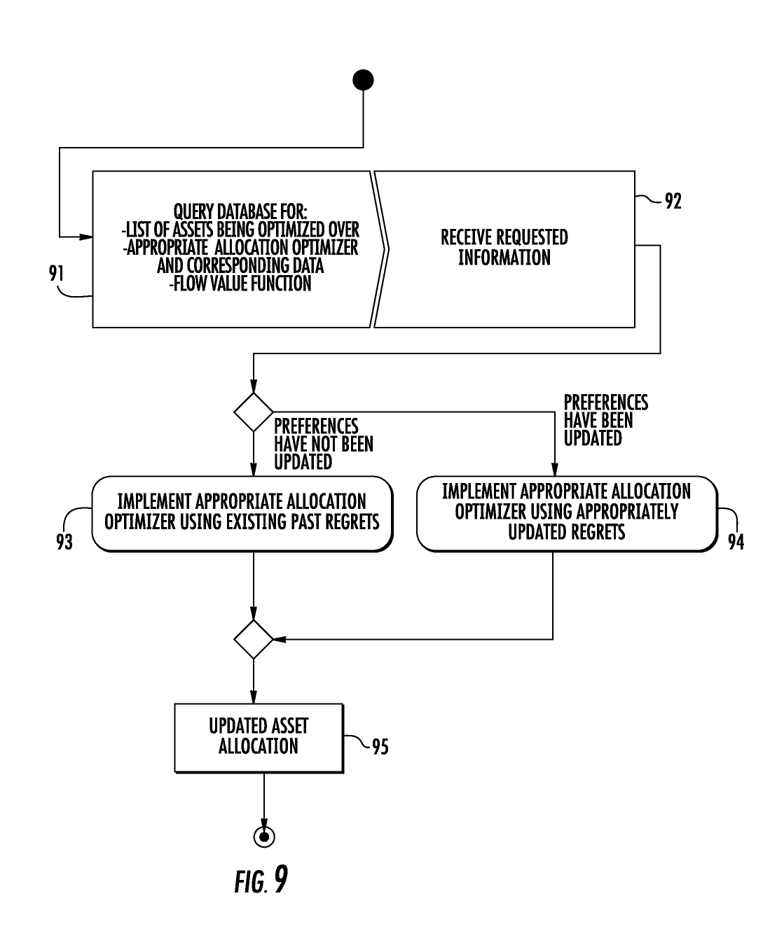

FIG. 9 is a flow diagram of a method to optimize among a number of possible allocation strategies by allowing to change the flow value function u measuring performance.

FIG. 9 represents a control layer to decide whether or not the value function u has been updated, and to adjust the allocation optimizer for new value functions if needed. Block 91 queries appropriate information, including the flow value function to optimize, which is received in block 92. If the flow value function u has not changed, block 93 corresponding to one of the allocation optimizers represented in FIG. 4, 5, 6, 7 or 8 is implemented. If the flow value function has changed, then block 94 which adjusts the allocation optimizer for new value functions is implemented.

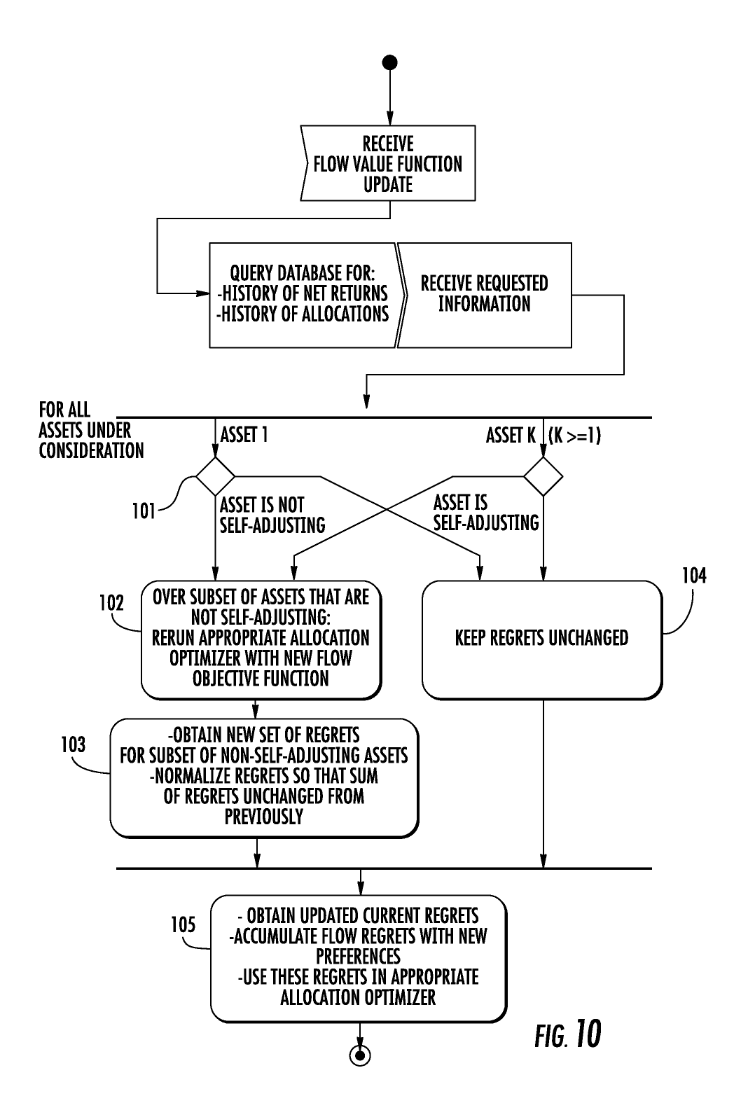

FIG. 10 is an embodiment of an implementation of block 93 shown in FIG. 9 for changes in value functions. Denote by û the new value function to be optimized. Denote by [symbol] _{κ,T} the new regret associated with asset κ.

The first operation, represented in block 101 is to classify the assets being optimized as being self-adjusting and non-self-adjusting. The asset is self-adjusting if the asset is really an allocation strategy, chosen by a manager, or a decision process, that already takes into account the change in preferences from u to û. The asset is non-self-adjusting if the asset is a fundamental asset, or an allocation strategy that is not adjusted as a function of flow value function u or û.

Block 102 specifies that for the set K^{NSA} of assets that are non-self-adjusting, regrets should be recomputed from scratch according to

$${κ , T}_{} = \begin{matrix}max \\ {T}^{′} \leq T\end{matrix} {\sum }_{t = {T}^{′}}^{T} \hat{u} ( {r}_{κ , t} , {\underline{ω}}_{t} ) - \hat{u} ( {\tilde{r}}_{t} , {\underline{ω}}_{t} )$$

where \tilde{r}ₜ are the returns generated by the allocation (ãₜ)_{t≧0} over non-self-adjusting assets defined by

$$∀ κ ∈ {K}^{NSA} , {\tilde{a}}_{κ , t} = \frac{{κ , t - 1}_{}}{{\sum }_{{κ}^{′} ∈ {K}^{NSA}} {{κ}^{′} , t - 1}_{}} .$$

Block 103 normalizes the regrets ( [symbol] _{κ,K})_{κ∈K}_{^{NSA}} to keep the regret weight of assets in K^{NSA} constant: to this effect updated regret [symbol] _{κ,T} is defined as

$${κ , T}_{} = {κ , T}_{} \times \frac{{\sum }_{{κ}^{′} ∈ {K}^{NSA}} {{κ}^{′} , T}_{}}{{\sum }_{{κ}^{′} ∈ {K}^{NSA}} {{κ}^{′} , T}_{}} .$$

Block 104 specifies that for assets K that are self-adjusting, regrets remain constant: [symbol] _{κ,T}= [symbol] _{κ,T}.

Block 105 obtains allocations going forward by using the procedures detailed in FIGS. 4, 5, 6, 7 and 8 where the updated regrets [symbol] _{ι,T} are used as new starting regrets, and flow regrets going forward are accumulated according to the new flow value function û. Specifically, if the change in value function occurs in period T₀, regrets [symbol] _{κ,T}_{₁} in period T₁≧T₀ are defined by

$${{κ}_{1} , {T}_{1}}_{} = max \{ {{κ}_{1} , {T}_{0}}_{} ; {max}_{{T}^{′} ∈ \{ {T}_{0 , … } {T}_{1} \}} {\sum }_{t = {T}^{′}}^{{T}_{1}} \hat{u} ( {r}_{κ , t} , {\underline{ω}}_{t} ) - \hat{u} ( {r}_{t} , {\underline{ω}}_{t} ) \} .$$

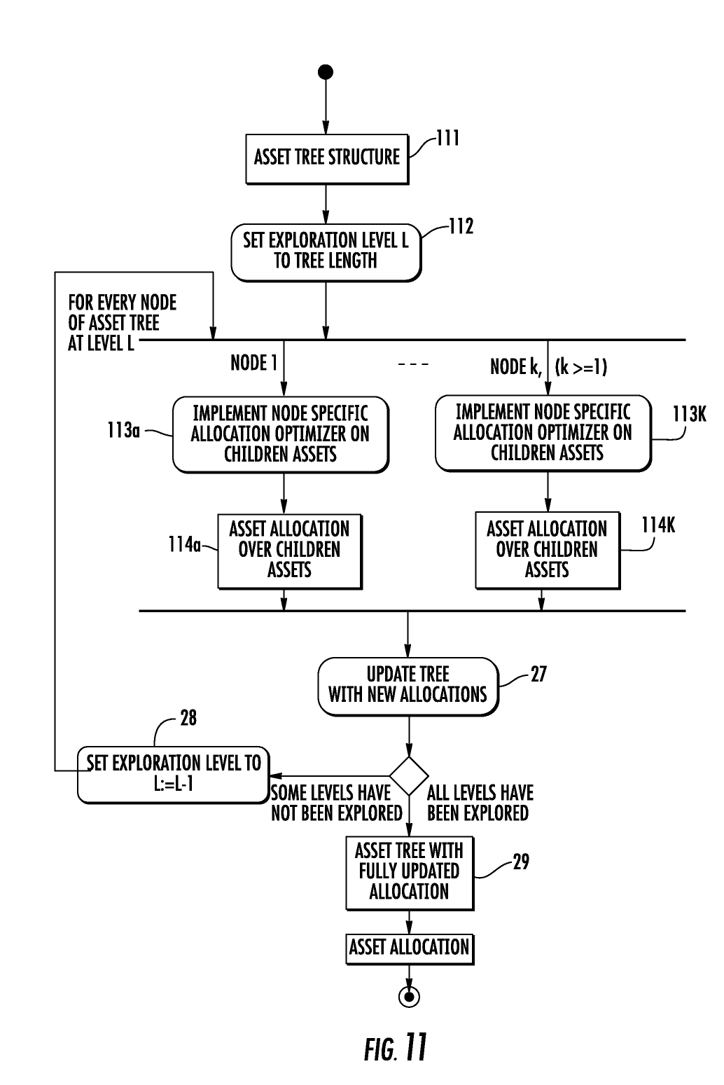

FIG. 11 is a flow diagram of a method to optimize among a number of possible allocation strategies by structuring the optimization process through an asset tree.

Block 111 specifies that the procedure takes as input an asset tree as that described in FIG. 3.

Block 112 indicates that the tree be explored in order of decreasing distance from the root. It will be appreciated that any ordering of nodes can be used.

Blocks 113a-113k specify that for each node, allocation of weights to children nodes are performed according to an allocation optimizer in blocks 114a-114k as in FIG. 4, 5, 6, 7, 8, or 9 and 10.

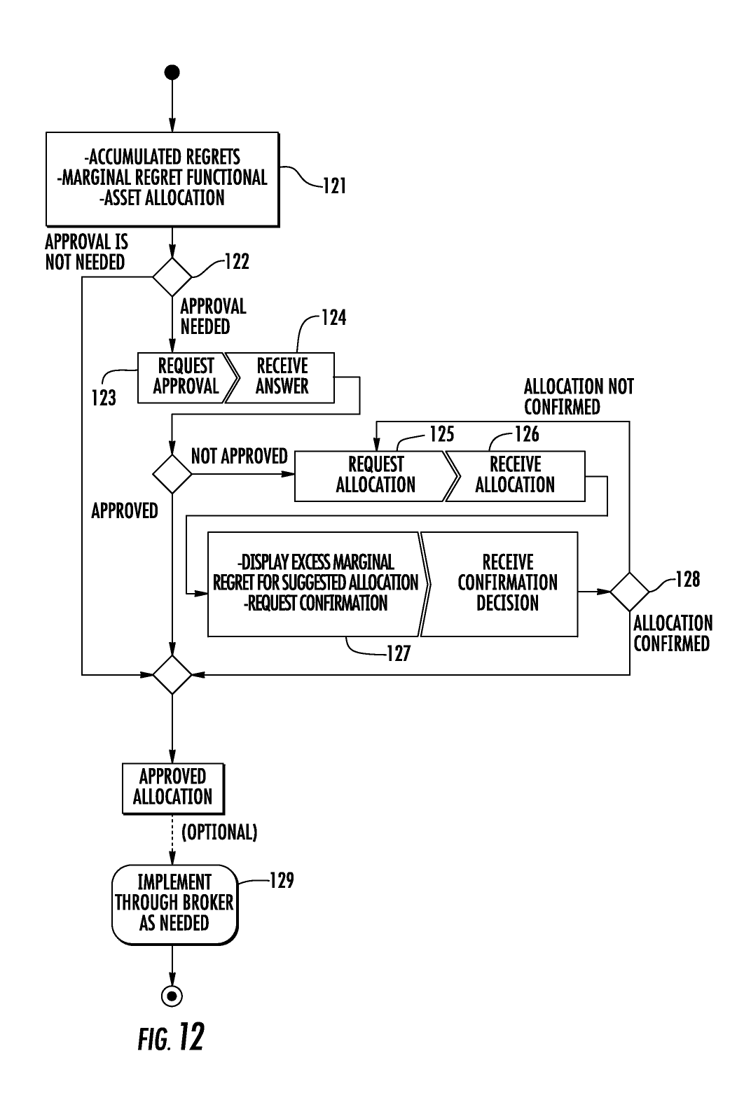

FIG. 12 is an implementation of a method to evaluate and validate asset allocations of block 13.

Block 121 specifies that at time T, the method takes as inputs accumulated regrets [symbol] _{T}=( [symbol] _{κ,T}, [symbol] _{c,T})_{κ∈K}; the marginal regret functional used in the allocation optimization procedure; and a suggested asset allocation. In block 122 it is determined if approval is needed for the suggested asset allocation. If approval is needed, approval of the suggested asset allocation is requested in block 123. An answer is received in block 124. If the allocation is not approved, an alternative allocation is requested in block 125 and received in block 126. Block 127 specifies that when the user does not approve the allocation a_{T} suggested by the system, and suggests a different allocation a′_{T}, the system displays the marginal regret ψ( [symbol] _{T},a_{T-1},a′_{T}) associated with this allocation, or a graphical representation thereof, and requests confirmation of the allocation a′_{T}. In block 128 it is determined if the allocation is confirmed. If the allocation is not confirmed, blocks 124 -127 are repeated. If the allocation is confirmed the approved allocation can be optionally implemented through a broker as needed in block 129.

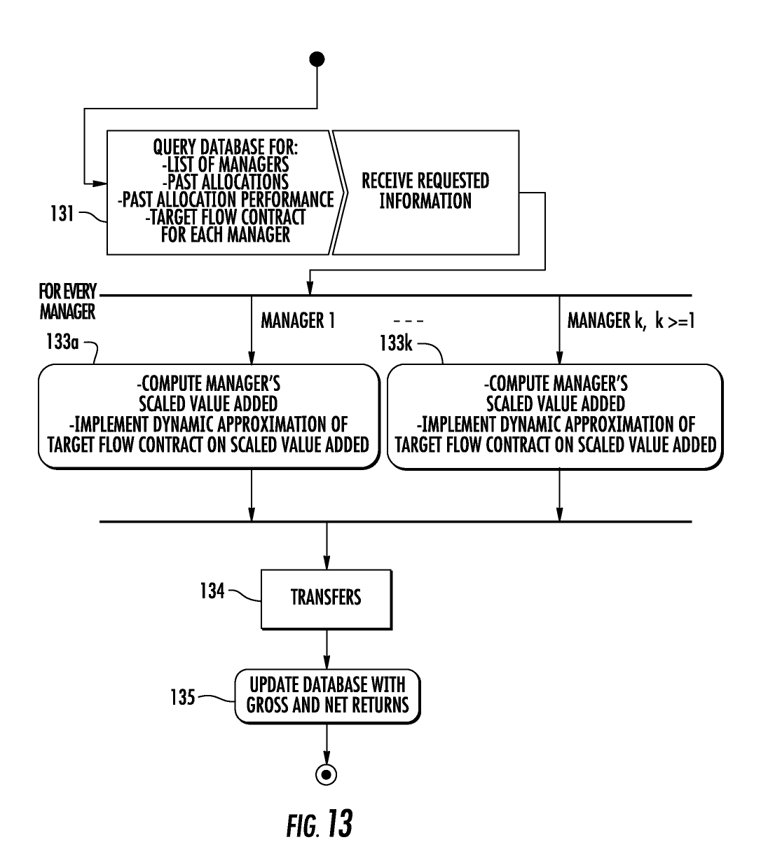

FIG. 13 is an implementation of a limited liability dynamic reward method of block 14.

Block 131 describes the data necessary for this procedure: a list of managers, and for each manager: past allocations; past performance; and target flow contract for this manager. In block 132, the requested data is received.

Blocks 133a-133k correspond to the main step of this implementation. For each manager m, a history of the manager's gross returns (r_{m,t})_{t≧0} , is constructed, as well the history of resources (w_{m,t})_{t≧0} the manager has been allocating. Let K^{m} denote the set of assets controlled by the manager (i.e., assets that correspond to an allocation strategy chosen by the manager, or for which the manager is the unique information provider). Manager m's resources ω_{m,t} and gross returns r_{m,t}^{g} in period t are,

$${\underline{ω}}_{m , t} = {\underline{ω}}_{t} \times {\sum }_{κ ∈ {K}^{m}} {a}_{κ , t}$$

$${r}_{m , t}^{g} = \frac{{\sum }_{κ ∈ {K}^{m}} {a}_{κ , t} {r}_{κ , t}}{{\sum }_{κ ∈ {K}^{m}} {a}_{κ , t}} .$$

Net returns for manager m, r_{m,t}, are gross returns r_{m,t}^{g} net of rewards to managers. Returns for the default manager (used as a benchmark for the manager m's performance), are denoted by r_{0,t}. This may be an allocation chosen by the client, a default allocation provided by an allocation optimizer as in block 12 and determined using only public information, or even some weighted average of a pre-specified allocation strategy, and the allocations chosen by other managers.

Rewards to managers are computed in blocks 133a-133k. The target contract in period t is a mapping φ(ω_{m,t},r_{m,t}^{g},t_{0,t}) which may take positive or negative values. Let φₜ≡φ(ω_{m,t}r_{m,t}^{g},r_{0,t}) denote the target transfer in period t. Appropriate examples of target contracts are

φ(ω_{m,t},r_{m,t}^{g},r_{0,t})=η×ω_{m,t}×(r_{m,t}^{g}−r_{0,t}),

φ(ω_{m,t},r_{m,t}^{g},r_{0,t})=η└(ln(1+r_{m,t}^{g})−ln(1+r_{0,t})┘,

or φ solving the fixed point equation

φ(ω_{m,t},r_{m,t}^{g},r_{0,t})=η└ln(1+r_{m,t}^{g}−φₜ/ω_{m,t})−ln(1+r_{0,t})┘,

for η>0 a scaling parameter. At time T, actual transfers π_{T} to the manager are set by π₀=0 and

$${π}_{T} = \{ \begin{matrix}max \{ {φ}_{t} , 0 \} & if {\sum }_{t = 0}^{T - 1} {π}_{t} \leq {\sum }_{t = 0}^{T - 1} {φ}_{t} \\ 0 & otherwise\end{matrix}$$

Variants of this dynamic transfer protocol are possible, including, any transfer strategy (πₜ)_{t≧0} calibrated so that (Σₜ₌₀^{T}πₜ)_{T≧0} approaches (Σₜ₌₀^{T}φₜ)_{T≧0}.

Transfers corresponding to rewards computed in blocks 133a-133k are implemented in block 134.

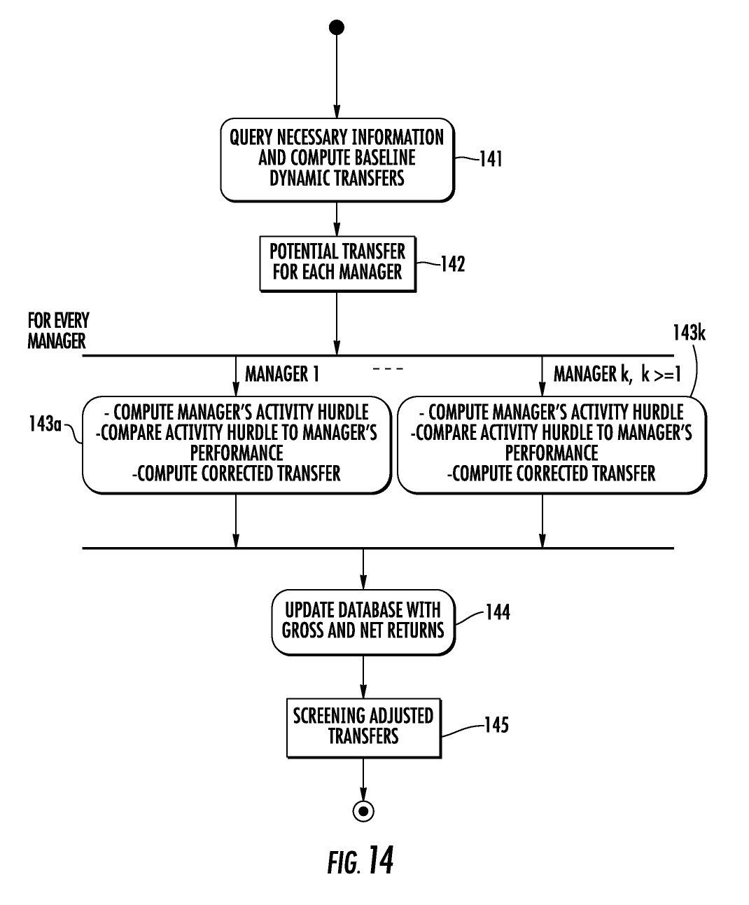

FIG. 14 is an embodiment of a limited liability dynamic reward protocol corresponding to block 14 which includes screening untalented agents. In block 141 a baseline dynamic transfer π_{T} is determined as described in blocks 132 and 133 of FIG. 13. Potential transfer π_{T} is returned in block 142.

Blocks 143a-143k specify that for each manager m, the manager's activity χ_{m,T} is computed according to

$${χ}_{m , T} = {\sum }_{t = 0}^{T} {( {r}_{m , t} - {r}_{0 , t} )}^{2} {\underline{ω}}_{m , t}^{2} .$$

The manager's activity hurdle is a function θ(χ_{m,T}) a priori increasing in χ_{m,T}. An appropriate specification of hurdle θ(χ_{m,T}) is

θ(χ_{m,T})=γ\sqrt{χ_{m,T}lnχ_{m,T}+M}=Θ_{m,T}

where γ and M are adjustment parameters. This hurdle will be compared to the manager's performance

$${S}_{m , T} = {\sum }_{t = 0}^{T} {\underline{ω}}_{m , t} ( {r}_{m , t} - {r}_{0 , t} ) .$$

Actual payments are as follows: if T=0, the manager must pay a participation fee b; if T>0 the manager receives payment π_{T} if S_{m,T}≧Θ_{m,T} and a payment of 0 if S_{m,T}<Θ_{m,T}

Participation fee b may be chosen so that b>v exp(−2M) where v is a scaling parameter. Additional participation fees may be requested in further periods.

Alternatively, b may be chosen such that expected profits are negative if performance S_{m,T} follows a Brownian motion with zero drift. In block 144 the financial information database is updated with gross and net returns. In block 145, transfers adjusted for screening are implemented.

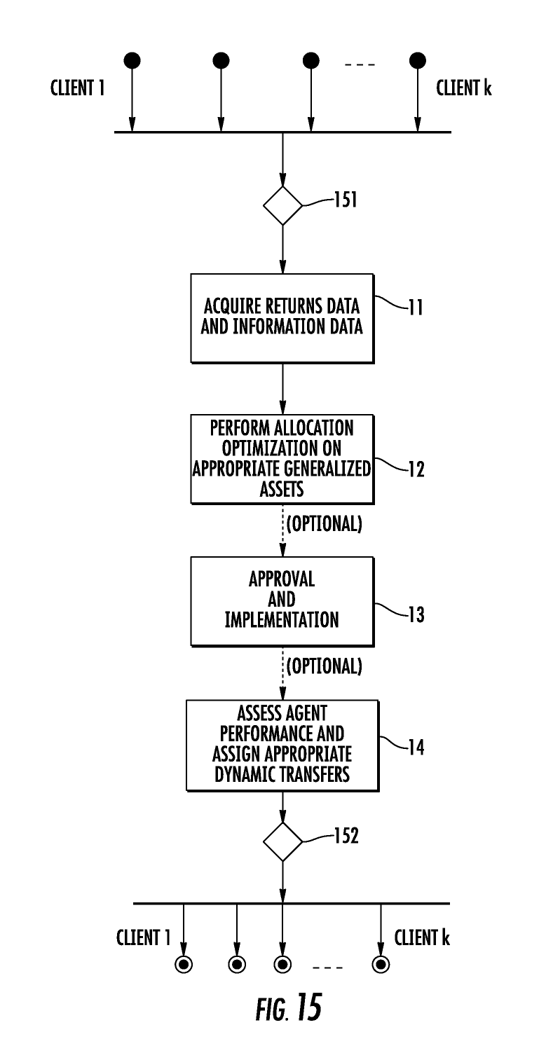

FIG. 15 is an embodiment of a method to structure the acquisition, exchange and usage of financial information that allows for multiple overlapping investors. In block 151, the resources ( ω̅_{i,t})_{i∈{1, . . . , l}} invested by investors i ∈ {1, . . . , k} at time t, are aggregated into total resources

$${\underline{ω}}_{t} = {\sum }_{i = 1}^{k} {\underline{ω}}_{i , t} .$$

The set of investors may change over time.

Aggregated resources (ωₜ)_{i∈{1, . . . , k}} are then invested as per the method specified in FIG. 1.

In block 152, resources generated through the investment process are distributed back to clients in proportion to their initial contributions.

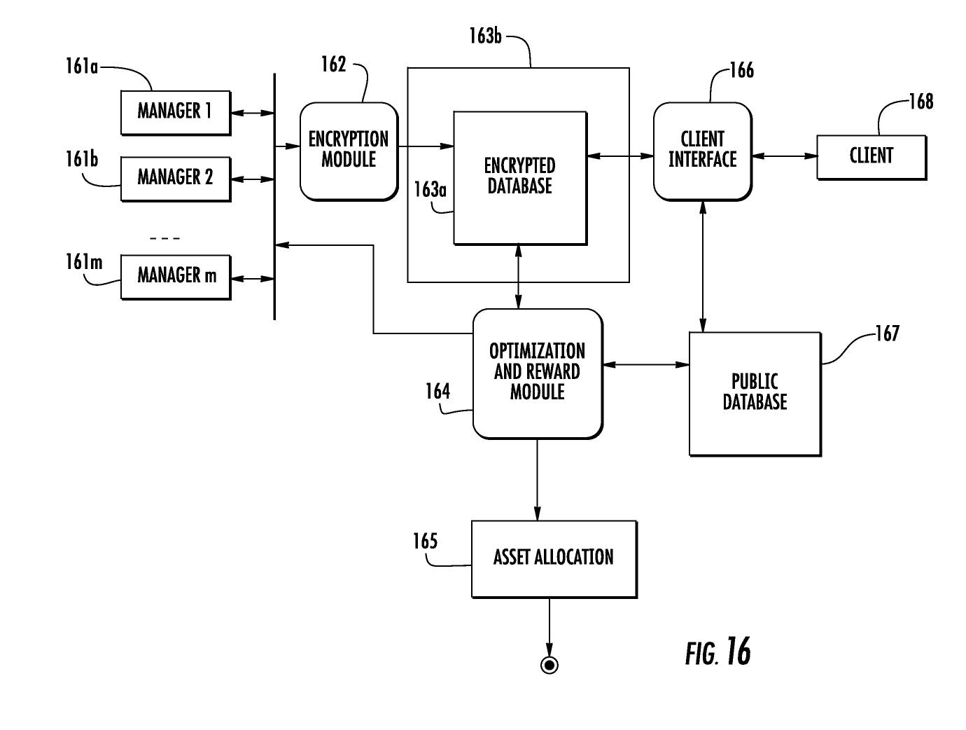

FIG. 16 describes a secure method to structure the acquisition, exchange, and usage of financial information. In blocks 161a-161m managers interact with the system by providing information and suggesting asset allocations, or by receiving transfers related to their value added and computed according to the methods of FIG. 13 or 14.

In block 162, information and asset allocation suggestions are encrypted and stored in a secure database represented in blocks 163a and 163b. The asset allocation optimization and reward design module 164 interacts securely with the encrypted database 163a-163b as well as a public information database 167 to compute optimized asset allocation 165, and rewards to potential managers. In one embodiment, implemented for education, evaluation or entertainment purposes, rewards to managers are implemented using fictitious currency or points, and prizes can be allocated, possibly by lottery, and as a function of points accumulated by the managers.

In block 166, client 168 may control the asset allocation process through a client interface which allows the client to view current asset balances and returns, as well as change the amount of resources invested. The client may not be able to view asset allocations in real time, but may receive frequent or real-time reports of general statistics concerning his portfolio, such as variance, cumulated performance, value-at-risk, allocation by broad asset categories, and the like. Managers may allow clients to view more specific information, including actual asset allocations under some conditions, for example, the client must pay an extra fee, or sign a no disclosure agreement.

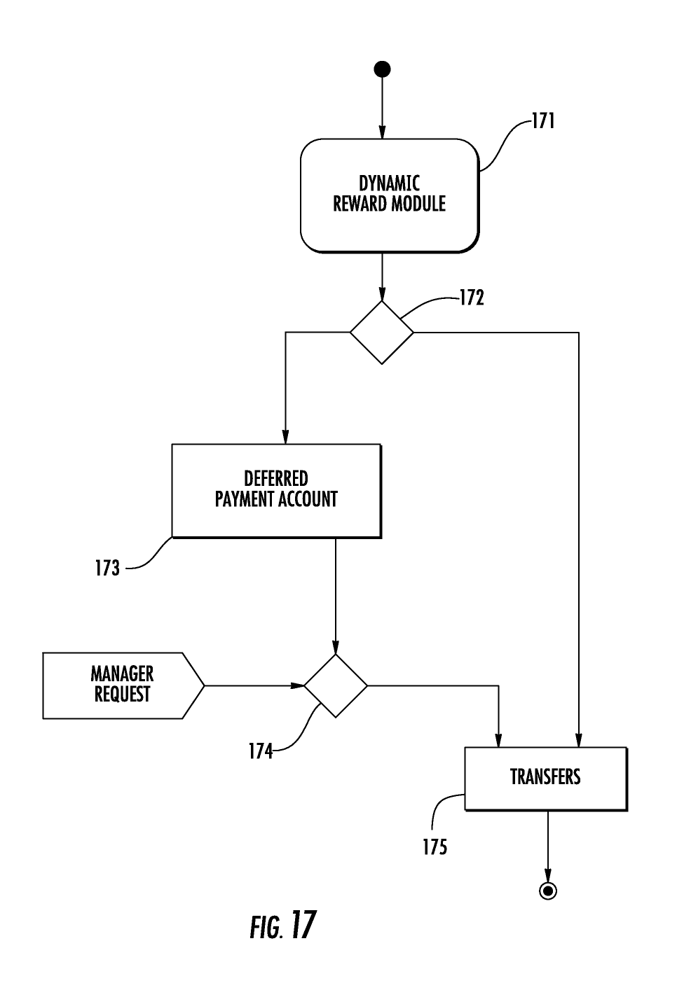

FIG. 17 is a block diagram of an embodiment of a deferred payment reward system complementing dynamic reward systems described in FIGS. 13 and 14 by delaying payment of part of a managers reward, and allowing the manager to claim the delayed reward conditional on an adequate performance hurdle being satisfied.

In block 171, a dynamic reward module is implemented as per FIGS. 13 and 14, possibly including the payment of screening fees by the manager as described in FIG. 14. In block 172, a pre-specified proportion (ρₜ)_{t≧0} of rewards, for example ρₜ=10% , is placed in deferred payment account 173, while the remaining proportion (1−ρₜ)_{t≧0} is transferred to the manager without delay as per block 175. Rewards placed in the manager's deferred payment account 173 may be required to be invested according to the manager's suggested asset allocations.

In block 174, the transfer of deferred payment is requested, either by the manager himself, or automatically at pre-specified time intervals or circumstances; said transfer is approved according to an appropriate deferred payment rule. The following is an example of a possible deferred payment rule. Given time periods T≦T′:
a performance hurdle Θ[T,T′] is computed according to

$$χ [ T , {T}^{′} ] = {\sum }_{t = T}^{{T}^{′}} {( {r}_{m , t} - {r}_{0 , t} )}^{2} {\underline{ω}}_{m , t}^{2}$$

and Θ[T,T′]=γ\sqrt{χ[T,T′]ln χ[T,T′]+M}, where γ and M are free adjustment parameters, which may be equal or differ from those chosen in FIG. 14;
transfer request of delayed reward ρ_{T}ρ_{T}, is approved if and only if performance over subperiod [T,T′] is greater than hurdle Θ[T,T′], i.e. if and only if

$$S [ T , {T}^{′} ] = {\sum }_{t = T}^{{T}^{′}} {\underline{ω}}_{m , t} ( {r}_{m , t} - {r}_{0 , t} ) \geq Θ [ T , {T}^{′} ] ;$$

upon approval, deferred payments are transferred to the manager in block 175.

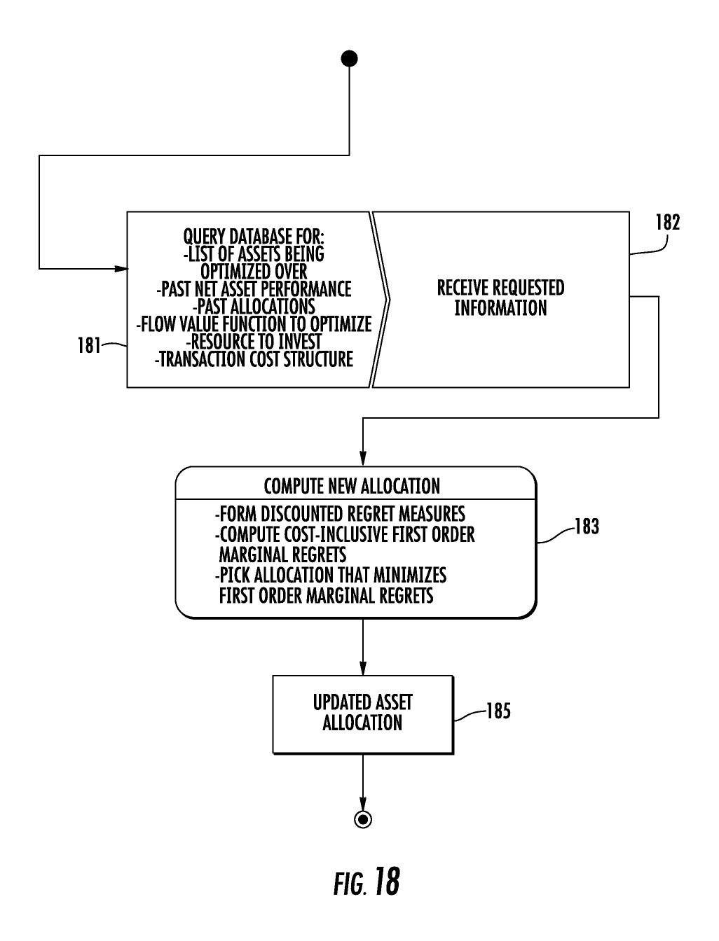

FIG. 18 is a block diagram of a robust and flexible allocation method expanding on the methods of FIGS. 4 and 5 by using discounted regrets as a basis for the optimization procedure.

In block 181, data of a list of assets being optimized over, past net asset performance, past allocations, flow value function to optimize, resources to invest, and potentially a transaction cost structure is queried and received in block 182.

In block 183, discounted regret measures using discount factors (β)_{t≧0} are computed. Discount factors (βₜ)_{t>0} are typically decreasing and can for instance take the form βₜ=exp(−ηt), where η>0 is a scaling parameter. Discounted regrets are computed according to

$${κ , T}_{β}^{} = \begin{matrix}max \\ {T}^{′} \leq T\end{matrix} {\sum }_{t = {T}^{′}}^{T} {β}_{T - t} [ u ( {r}_{κ , t} , {\underline{ω}}_{t} ) - u ( {r}_{t} , {\underline{ω}}_{t} ) ] and$$

$${c , T}_{} = {\sum }_{t = 0}^{T} {β}_{T - t} c ( {a}_{t - 1} , {a}_{t} , {\underline{ω}}_{t} ) .$$

Optimized allocation (a_{T})_{T≧0} is chosen to minimize the accumulation of additional discounted regrets [symbol] _{T}^{β}=( [symbol] _{κ,T}^{β}, [symbol] _{c,T}^{β})_{κ∈{1, . . . , K}}. This can be achieved by picking the allocation a_{T} that minimizes marginal regret functional

$$ψ ( {T - 1}_{β}^{} , {a}_{T - 1} , {a}_{T} ) = \vert {\sum }_{κ ∈ K} ( {κ , T - 1}_{β}^{} - {a}_{κ , T} {\sum }_{\hat{κ} ∈ K} {\hat{κ} , T - 1}_{β}^{} ) \vert + γ ( T , {T - 1}_{β}^{} ) c ( {a}_{T - 1} , {a}_{T} , {\underline{ω}}_{T} )$$

where γ(•,•) is a weight function that-for instance-can be chosen of the form

γ(T, [symbol] _{T-1}^{β})=γ₀T^{ρ}+γ₁[ [symbol] _{c,T-1}^{β}]^{φ}

with γ₀, γ₁, ρ and φ positive parameters. For example, γ₀=0, γ₁=1 and φ=1; or γ₀=1, γ₁=0 and ρ=⅔ can be selected. Generally, parameters γ₀, γ₁, ρ and φ can be optimized to obtain good performance on past data.

The resulting optimized asset allocation is returned in block 185.

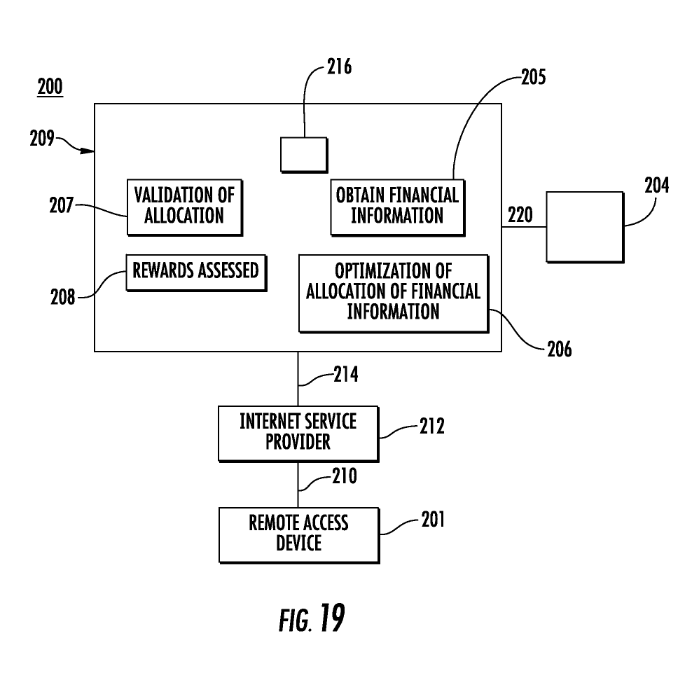

FIG. 19 is a block diagram of an illustrative system 200 in accordance with the present invention. In one embodiment, remote access device 201 can request access to financial information database 204, acquiring financial information application 205, optimization of allocation to financial instruments application 206, validation of asset allocation application 207, and performance assessment and reward design application 208 from central facility 209 via communications link 210, Internet Service Provider (ISP) 212, and communications network 214. Central facility 209 can include server 216 for receiving and processing the request from remote access device 201. Server 216 may provide remote device 201 with access only when a client associated with the device has paid or has contracted to pay a requisite access fee. For example, remote device 201 can request access to one or more web pages that implement a method for the acquisition, exchange and usage of financial information (FIGS. 1-18).

Remote access device 201 can be any remote device capable of using a browser to request access from central facility 209 such as, for example, a personal computer, a wireless device such as a laptop computer, a cell phone or a personal digital assistant (PDA), or any other suitable remote access device having a browser implemented thereon. Multiple remote access devices 201 can be included in system 200 (e.g., to allow a plurality of users at a corresponding plurality of remote access devices to access financial information from central facility 209), although only one remote access device 201 has been included in FIG. 19 to avoid over-complicating the drawing.

Server 216 can include a distinct component of computing hardware or storage for receiving and processing requests from remote access device 201, but may also be a software application or a combination of hardware and software. Server 216 can be implemented using one or more computers. For example, a single computer may have software that enables the computer to perform the functions of server 216. As another example, server 216 may be implemented using multiple computers.

Acquiring financial information application 205, optimization of allocation to financial instruments application 206, validation of asset allocation application 207, and performance assessment and reward design application 208 can be any suitable software, hardware, or combination thereof for performing blocks of the flow charts shown in FIGS. 1-18 in accordance with the present invention. Financial data can be retrieved by application 205 from one or more financial information databases 204 over communications links 210 and 220. Values corresponding to information generated by applications 206-208 can be stored in database(s) 204 (e.g., for access by remote access device 201).

Acquiring financial information application 205, optimization of allocation to financial instruments application 206, validation of asset allocation application 207, performance assessment and reward design application 208and server 216 are shown in FIG. 19 as being implemented at central facility 209. However, in some embodiments of the present invention, acquiring financial information application 205, optimization of allocation to financial instruments application 206, validation of asset allocation application 207, performance assessment and reward design application 208, and server 216 can be implemented at separate facilities and/or in a distributed arrangement. For example, acquiring financial information application 205, optimization of allocation to financial instruments application 206, validation of asset allocation application 207, performance assessment and reward design application 208, and server 216 can be at least partially implemented at remote access device 201.

Each of communications links 210 and 220 and communications network 214 can be any suitable wired or wireless communications path or combination of paths such as, for example, a local area network, wide area network, telephone network, cable television network, intranet, or Internet. Some suitable wireless communications networks may be a global system for mobile communications (GSM) network, a time-division multiple access (TDMA) network, a code-division multiple access (CDMA) network, a Bluetooth network, or any other suitable wireless network.

In accordance with another embodiment of the present invention, a computer-readable medium (e.g., CD-ROM, DVD, computer disk or any other suitable memory device) can be encoded with financial information (e.g., information from database 204) and/or computer-executable instructions for performing the functions of acquiring financial information application 205, optimization of allocation to financial instruments application 206, validation of asset allocation application 207, and performance assessment and reward design application 208 (e.g., blocks 11-14 of FIG. 1), and the medium may be offered for sale to consumers.

The invention can be further illustrated by the following examples thereof, although it will be understood that these examples are included merely for purposes of illustration and are not intended to limit the scope of the invention unless otherwise specifically indicated.

The computations and data manipulations of FIGS. 1-18 are to be implemented on a computer. An embodiment of the invention has been implemented for laboratory testing purposes.

It has been found that the present invention provides adequate allocation optimization and successfully aligns the interests of managers and their clients.

A laboratory experiment on individuals placed in a simulated trading environment confirms that analysis, comparing the returns generated by the present invention to the returns generated by a current alternative system of high-watermark contracts, and an idealized high-liability alternative of full clawback. The following table compares the performance of various methods.

| Management and reward system | Per-period returns | Performance index |
|---|---|---|
| High-watermark | 1.42% | 100 |
| Full clawback | 1.94% | 136 |
| Present invention of method 10 | 1.96% | 137 |

The results indicate that the present invention provides large performance gains compared to conventional systems, up to the level of productivity gains accorded by a high-liability management system with full clawbacks.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A computer implemented method for optimizing resource allocation over a plurality of assets comprising the steps of:
acquiring financial information on the assets in a computer;
robustly optimizing asset allocation for weighing the resource across the assets;
wherein the asset allocation optimization method dynamically optimizes between one or more of fixed allocations over fundamental assets, pre-specified information-dependent allocation strategies, allocation strategies suggested by managers, and allocation strategies suggested by a client.

2. The method of claim 1 wherein the acquired financial information is dynamically stored in a tree structure in said computer, said assets are represented by one or more leaves of said tree, and nodes of said tree are used to categorize said assets.

3. The method of claim 1 wherein said acquiring financial information step comprises:
querying a database for data of a list of assets being optimized over, past net asset returns, past net asset performance, past allocations, a flow value function to be maximized, and resources to be invested;
and receiving the data; and
wherein said optimizing step comprises:
determining regret measures over possible underlying assets; and
selecting the asset allocation that robustly limits accumulation of additional regrets.

4. The method of claim 3 wherein the regret measures are determined by computing maximum foregone performance, and regrets are minimized by using allocations taking the form of regret weighted averages, or following a gradient descent protocol.

5. The method of claim 4 wherein said acquiring financial information step further comprises:
querying a database for a trading cost structure;
receiving the data; and
wherein said optimizing step further comprises:
determining regret measures over possible underlying assets;
determining a regret measure over trading costs; and
selecting the asset allocation that robustly minimizes additional marginal regrets, including trading cost regret.

6. The method of claim 5 wherein said acquiring financial information step further comprises:
querying a database for data of a list of assets being optimized over and a set of permissible leveraged allocations;
receiving the data, and
wherein said optimizing step further comprises:
determining for each leveraged allocation an associated composite asset;
assembling relevant performance and returns data for the composite asset and dynamically optimizing allocation over the set of composite assets.

7. The method of claim 6 wherein said acquiring financial information step further comprises:
querying a database for data of a list of assets being optimized over and a history of states; and
receiving the data; and
wherein said optimizing step further comprises determining relevant performance and allocation history for each state, and optimizing allocation over assets according to the state relevant data, thereby yielding a state-dependent allocation.

8. The method of claim 7 wherein said acquiring financial information step further comprises:
querying a database for data of a list of assets being optimized over and a history of labels for assets; and
receiving the data; and
wherein said optimizing step further comprises:
constructing for each label an aggregated history of returns for assets that have been assigned said label, as well as the history of allocations to said assets, thereby forming label-based assets; and
dynamically optimizing allocation of resources over said label-based assets.

9. The method of claim 3 further comprising the step of determining if the flow value function has changed and if the flow value function has changed updating the regret measure and determining the asset allocation that robustly limits accumulation of additional regret over the updated regret measure.

10. The method of claim 9 wherein:
if the flow value function has changed performing the steps of determining if the asset is self-adjusting or non-self adjusting;
if the asset is determined to be self-adjusting the regret measure is unchanged;
if the asset is determined to be non-self adjusting the regret measure is recomputed, using the updated value function, for the subset of assets that are not self- adjusting to obtain regret measures for the subset of non-self adjusting assets; and
determining an asset allocation that robustly limits accumulation of additional regrets over all assets.

11. The method of claim 2 wherein each of the nodes of said tree include a node specific optimizer on children assets to determine dynamically optimized resource allocation to children nodes.

12. The method of claim 11 wherein each of the nodes includes a subset of information of: a name for the node, a list of children nodes or leaves, a list of managers allowed to input information or suggest asset allocations, a history of weight allocations over children nodes or leaves, a history of labels associated with children nodes, a history of information states associated with the node, the history of returns, such as gross and net, and a trading cost structure over children nodes specifying the cost of moving from one allocation over children nodes to an other.

13. The method of claim 1 further comprising the steps of:
evaluating the asset allocation and implementing the evaluated asset allocation.

14. The method of claim 13 wherein if approval is need by a user and a user does not approve of the asset allocation, the user can request a new asset allocation, and further comprising the steps of displaying a representation of excess regrets associated with the new asset allocation, and receiving confirmation of the allocation given the displayed excess regrets.

15. The method of claim 1 further comprising the steps of:
dynamically evaluating the performance of agents providing financial information and suggesting asset allocations; and
determining appropriately designed rewards for agents providing financial information and suggesting asset allocations.

16. The method of claim 15, further comprising the steps of:
requiring managers to pay a screening fee; and
implementing rewards to managers contingent on their performance being above an appropriately designed performance hurdle.

17. The method of claim 1 wherein resources to be invested are collected from multiple investors which can be changing over time, and realized returns are distributed to the multiple investors in proportion to their initial contribution.

18. The method of claim 1 wherein information provided by the managers is securized, and the clients' ability to view detailed information on the financial information and the asset allocations provided by the managers is limited, or made contingent on approval by the concerned manager.

19. The methods of claim 15, further comprising the steps of:
deferring a pre-specified proportion of the manager's reward to a deferred payment account, which can be invested according to the manager's suggested asset allocations; and
following request by manager, or at pre-specified time intervals, determining whether deferred rewards are eligible for transfer and implementing said transfer upon approval.

20. The method of claim 16, further comprising the steps of:
deferring a pre-specified proportion of the manager's reward to a deferred payment account, which can be invested according to the manager's suggested asset allocations; and
following request by manager, or at pre-specified time intervals, determining whether deferred rewards are eligible for transfer and implementing said transfer upon approval.

21. The method of claim 3, wherein regret measures to be minimized are discounted over time using pre-specified discount factors.

22. The methods of claim 15, implemented for education, evaluation or entertainment purposes, wherein rewards to managers are implemented using fictitious currency or points, and prizes can be allocated, and as a function of points accumulated by the managers.

23. The methods of claim 16, implemented for education, evaluation or entertainment purposes, wherein rewards to managers are implemented using fictitious currency or points, and prizes can be allocated, and as a function of points accumulated by the managers.
